(19) United States
(12) Patent Application Publication
(10) Pub. No.: US 2024/0229829 A1
(43) Pub. Date: Jul. 11, 2024

(54) COMPRESSED AIR-MOISTURE SEPARATING UNIT FOR MULTISTAGE TURBOCOMPRESSOR SYSTEM

(71) Applicant: TURBOWIN CO., LTD., Cheongju-si (KR)

(72) Inventor: Minsoo KIM, Daejeon (KR)

(73) Assignee: TURBOWIN CO., LTD., Cheongju-si (KR)

(21) Appl. No.: 18/540,034

(22) Filed: Dec. 14, 2023

(30) Foreign Application Priority Data
Jan. 6, 2023 (KR) 10-2023-0002450

(51) Int. Cl. F04D 29/70; B01D 45/16; B01D 50/20; F04D 17/12

(52) U.S. Cl. CPC F04D 29/706; B01D 45/16; B01D 50/20; F04D 17/12

(57) ABSTRACT

Disclosed is a compressed air-moisture separating unit for a multistage turbocompressor system, and more specifically, to a compressed air-moisture separating unit for a multistage turbocompressor system that enables optimum compressed air to be obtained and discharged by removing moisture from compressed air compressed in the multistage turbocompressor system.

### BACKGROUND OF THE PRESENT INVENTION

### Field of the Present Invention

The present invention relates to a compressed air-moisture separating unit for a multistage turbocompressor system, and more specifically, to a compressed air-moisture separating unit for a multistage turbocompressor system that enables optimum compressed air to be obtained and discharged by removing moisture from compressed air compressed in the multistage turbocompressor system.

### Description of the Related Art

A compressed air is used for various purposes in various industrial sites.

The compressed air is an air created at high pressure by being pressurized by means of an air compressor and reducing its volume.

In other words, the compressed air is an air whose volume has been reduced by applying pressure above a certain pressure thereto, and is an air whose density has increased at a pressure higher than an atmospheric pressure.

In such compressed air, moistures, oils, and various impurities contained in the atmosphere are condensed together in the process of compressing the air in the atmosphere.

As the moisture contained in the compressed air flows, it changes into condensate, and the changed condensate causes serious problems in the compression system.

Additionally, the quality of the compressed air is determined by its moisture content.

In other words, the lower the moisture content, the better the quality.

The high-quality compressed air not only maximizes energy efficiency, but is also directly connected to the improvement of the safety and stability of the system of receiving the compressed air.

Therefore, the present invention seeks to provide a compressed air-moisture separating unit for a multistage turbocompressor system that can obtain high-quality compressed air from which moisture has been removed.

In the meantime, as a prior art for the compressed air-moisture separating unit for the multistage turbocompressor system, “A trap device for a moisture removal system of a vacuum pump” of Korean Patent Registration No. 10-1868915 (hereinafter referred to as “Patent Literature 1”) is disclosed as shown in FIG. 7A.

Patent Literature 1 relates to a trap device for a moisture removal system of a vacuum pump, capable of effectively removing foreign matters and moisture, which are included in air sucked from an object to be evacuated to flow in the vacuum pump. According to the invention, the trap device is connected to the vacuum pump, which sucks the air from the object to be evacuated to form a negative pressure inside the object to be evacuated, to remove the foreign matters from the air sucked into the vacuum pump. The trap device comprises a housing having a plurality of compartments vertically formed therein; an inlet pipe inserted into the housing from the upper part of the housing to transfer the air flowing from the object to be evacuated to the compartment placed in the lowermost end of the housing among the compartments; and a trap oil filled in the compartment placed in the lowermost end. The air transferred into the compartment placed in the lowermost end of the housing through the inlet pipe moves to the upper part of the housing through the trap oil, and the compartment placed in the lowermost end of the housing is connected to the vacuum pump, thereby allowing the air to be sucked into the vacuum pump.

As another prior art for the compressed air-moisture separating unit for the multistage turbocompressor system, “A moisture removal system for a vacuum pump” of Korean Patent Registration No. 10-1868914 (hereinafter referred to as “Patent Literature 2”) is disclosed as shown in FIG. 7B.

Patent Literature 2 relates to a moisture removal system for a vacuum pump, capable of effectively removing moisture, which is included in air sucked from an object to be evacuated to flow into a vacuum pump. According to the invention, the moisture removal system for a vacuum pump comprises the vacuum pump sucking air from an object to be evacuated to form a negative pressure inside the object to be evacuated; and a sub vacuum pump to suck the internal air of the vacuum pump. The moisture included in the air sucked from the object to be evacuated and flow into the vacuum pump is condensed inside the vacuum pump. When the pressure inside the vacuum pump is lowered by the sub vacuum pump, condensate generated by being condensed inside the vacuum pump is evaporated to be discharged to the outside of the vacuum pump by the sub vacuum pump.

As described above, Patent Literatures 1 and 2 are the same technical field as the present invention and have similar and identical technical concepts in terms of the basic elements of the present invention and the object of the present invention for removing moisture contained in the air flowing into the air suction device in comparison with the present invention. However, there is a difference in terms of subject matters to be solved by the invention, solution means for solving it, and an effect exerted by solving the same.

In other words, Patent Literature 1 relates to the trap device that can effectively remove the foreign matters and moisture contained in the air sucked from the vacuum object and flowing into the vacuum pump and Patent Literature 2 relates to the moisture removal system for the vacuum pump that can effectively remove the foreign matters and moisture contained in the air sucked from the vacuum object and flowing into the vacuum pump. However, in comparison with the present invention, there are differences in technical characteristics in specific solutions (components) of the invention for solving the problem to be solved by the invention and exerting the effect thereof.

Accordingly, the present invention is different from the technologies for the conventional device and system for removing the moisture from the compressed air including the Patent Literature 1 and Patent Literature 2. Also, the present invention seeks to achieve the technical features based on the problem to be solved by the invention (object of the invention), the solution means (element) for solving it, and the effect exerted by solving the same.

### PATENT LITERATURE

Patent Literature 1: Korean Patent Registration No. 10-1868915 (Jun. 19, 2018)

Patent Literature 2: Korean Patent Registration No. 10-1868914 (Jun. 20, 2018)

### SUMMARY OF THE PRESENT INVENTION

In this respect, the present invention is made to solve the above-described problem, and an object thereof is to provide a compressed air-moisture separating unit for a multistage turbocompressor system that enables optimum compressed air from which moisture has been removed to be obtained.

In other words, the object of the present invention is to provide a safe and stable multistage turbocompressor system equipped with a compressed air-moisture separating unit to an industrial site where compressed air is used, by obtaining and discharging optimum compressed air from which moisture has been removed and thereby ensuring and maximizing the durability and service life of the multistage turbocompressor system as well as energy efficiency.

According to an aspect of the present invention to achieve the object described above, there is provided a compressed air-moisture separating unit for a multistage turbocompressor system, the compressed air-moisture separating unit including: a cylindrical compressed air-moisture separation chamber housing module that enables condensed moisture to be separated from compressed air when the compressed air compressed by a turbo air compression unit flows in; a compressed air inlet module that is formed by penetrating one side of an upper part of the compressed air-moisture separation chamber housing module and is separated from a central axis of the compressed air-moisture separation chamber housing module on purpose such that the compressed air discharged from the turbo air compression unit flows in and whirls inside the compressed air-moisture separation chamber housing module; an intra-compressed air moisture-removal flow guide vane module that is rotated by the compressed air flowing in the compressed air inlet module, facilitates whirling of the compressed air flowing in the compressed air-moisture separation chamber housing module, induces the compressed air to flow to an intra-compressed air moisture-removal filtering housing module, and induces friction with the compressed air to remove condensed moisture from the compressed air; the intra-compressed air moisture-removal filtering housing module that is positioned coaxially inside the compressed air-moisture separation chamber housing module and is formed in a specific shape to remove condensed moisture from the compressed air flowing in the compressed air-moisture separation chamber housing module and discharge, to the outside, the compressed air from which the condensed moisture has been removed; and a condensed moisture discharging mesh module that enables the condensed moisture removed from the compressed air and condensed moisture droplets floating inside the compressed air-moisture separation chamber housing module to be formed and discharged as moisture to the outside, wherein the compressed air flowing in through the compressed air inlet module flows through a moisture-removed compressed air discharge route that is formed from the compressed air inlet module through an inner upper end portion of the compressed air-moisture separation chamber housing module and then the intra-compressed air moisture-removal flow guide vane module to an inside of the intra-compressed air moisture-removal filtering housing module such that the compressed air from which the condensed moisture has been removed is discharged to the outside, primary removal of the condensed moisture is performed due to friction of the compressed air flowing in the compressed air-moisture separation chamber housing module through the compressed air inlet module against the inner upper end portion of the compressed air-moisture separation chamber housing module, secondary removal of the condensed moisture is performed due to friction against the intra-compressed air moisture-removal flow guide vane module, tertiary removal of the condensed moisture is performed due to friction of the compressed air against an inner wall of the compressed air-moisture separation chamber housing module and an outer wall of the intra-compressed air moisture-removal filtering housing module, quaternary removal of the condensed moisture is performed due to friction of the compressed air against an inner wall of a lower end portion of the intra-compressed air moisture-removal filtering housing module, and as a result, moisture is removed from the compressed air compressed by the turbo air compression unit, and optimum compressed air is reliably obtained.

In the meantime, it should be understood that the terminology or the words used in claims should not be interpreted in normally or lexically sense. It should be interpreted as meaning and concept consistent with the technical idea of the present invention, based on the principle that the inventor can properly define the concept of the term in order to describe its invention in the best way.

Therefore, the embodiments described in the present specification and the configurations shown in the drawings are only the most preferred embodiments of the present invention, and not all the technical ideas of the present invention are described. Therefore, it is to be understood that various equivalents and modifications are possible.

### BRIEF DESCRIPTION OF THE DRAWINGS

The above and other objects, features and advantages of the present invention will be more apparent from the following detailed description taken in conjunction with the accompanying drawings, in which:

FIG. 1 illustrates a configuration diagram of a compressed air-moisture separating unit for a multistage turbocompressor system of the present invention'

FIG. 2 illustrates a piping and instrumentation diagram (P & ID) for a multistage turbocompressor system equipped with the compressed air-moisture separating unit for a multi-stage turbocompressor system of the present invention (four-stage compression);

FIG. 3 illustrates a schematic view of the compressed air-moisture separating unit for a multi-stage turbocompressor system of the present invention;

FIG. 4 illustrates a first reference view of the compressed air-moisture separating unit for a multi-stage turbocompressor system of the present invention;

FIG. 5 illustrates a second reference view of the compressed air-moisture separating unit for a multi-stage turbocompressor system of the present invention;

FIG. 6 illustrates a third reference view of the compressed air-moisture separating unit for a multi-stage turbocompressor system of the present invention;

FIG. 7A is a representative view of Patent Literature 1 for a compressed air-moisture separating unit for a multistage turbocompressor system according to the present invention; and

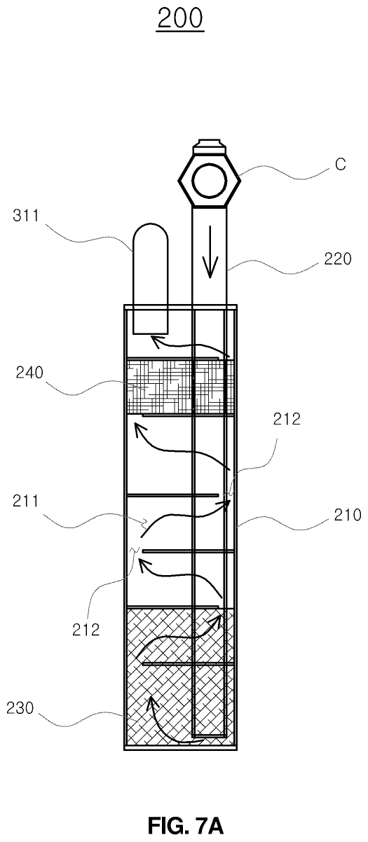

FIG. 7B is a representative view of Patent Literature 2 for a compressed air-moisture separating unit for a multistage turbocompressor system according to the present invention.

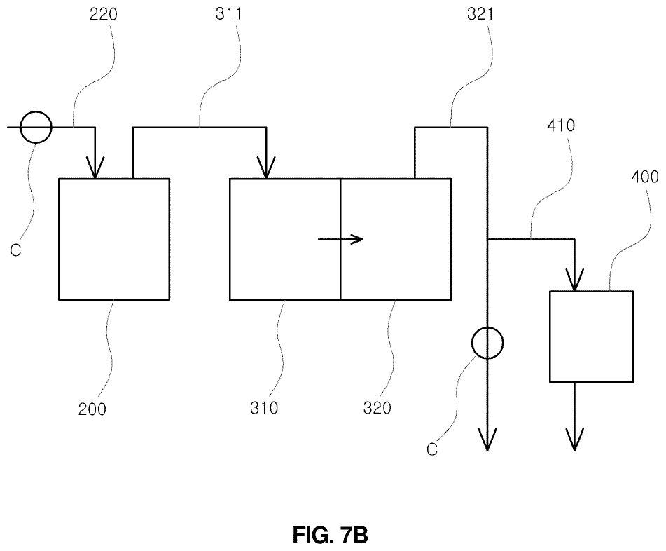

### REFERENCE SIGNS LIST

1: multistage turbocompressor system equipped with the compressed air-moisture separating unit
100: outside air intake unit
200: outside air filtering unit
300: turbo air compression unit
400: turbo air compression cooling unit
500: turbo air compression power supply unit
600: compressed air cooling intercooler unit
700: compressed air-moisture separating unit
710: compressed air-moisture separation chamber housing module
711: intra-compressed air condensed moisture-removal whirling space upper-end element
712: intra-compressed air condensed moisture-removal whirling space body element
713: intra-compressed air condensed moisture-removal whirling space bottom element
713a: condensed moisture outlet
720: compressed air inlet module
730: intra-compressed air moisture-removal flow guide vane module
740: intra-compressed air moisture-removal filtering housing module
741: intra-compressed air moisture-removal filtering element
742: moisture-removed compressed air discharge passage element
750: condensed moisture discharging mesh module
800: compressed air outlet unit
810: compressed air external-supply discharge module
820: compressed air internal-supply discharge module
821: blow-off valve element
822: compressed air volume control valve element
823: compressed air exhaust noise preventing muffler element
R: moisture-removed compressed air discharge route

### DETAILED DESCRIPTION OF THE PREFERRED EMBODIMENT

Hereinafter, functions, configurations, and operations of a compressed air-moisture separating unit (700) for a multistage turbocompressor system of the present invention will be described in detail with reference to the accompanying drawings.

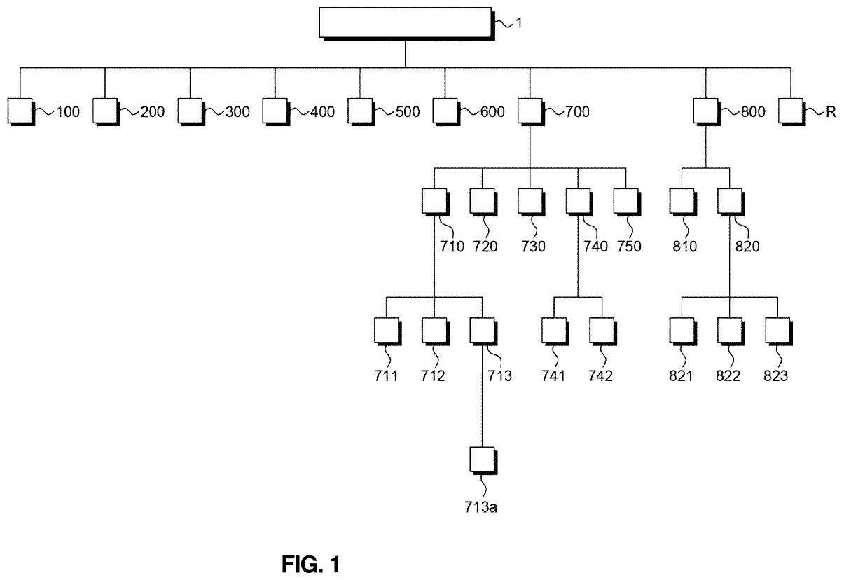

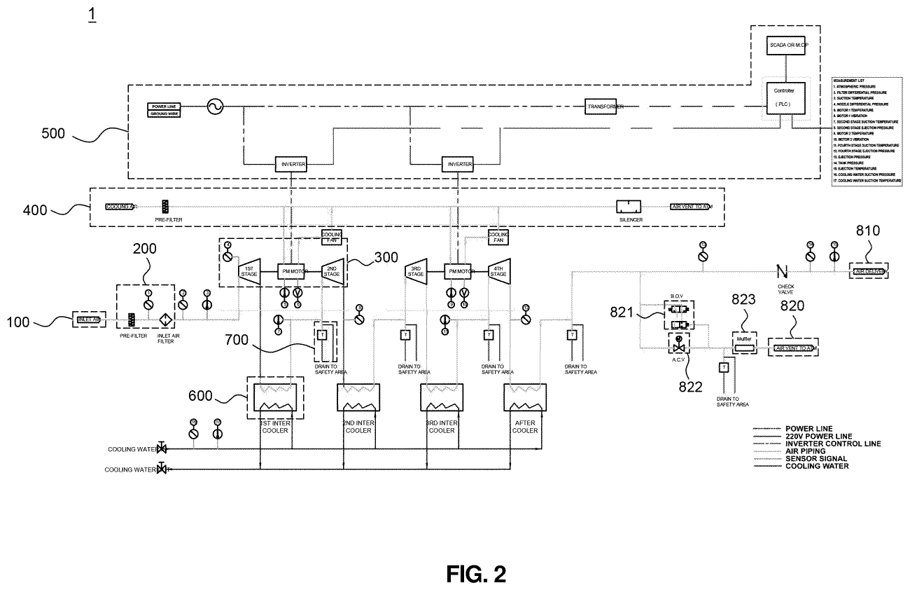

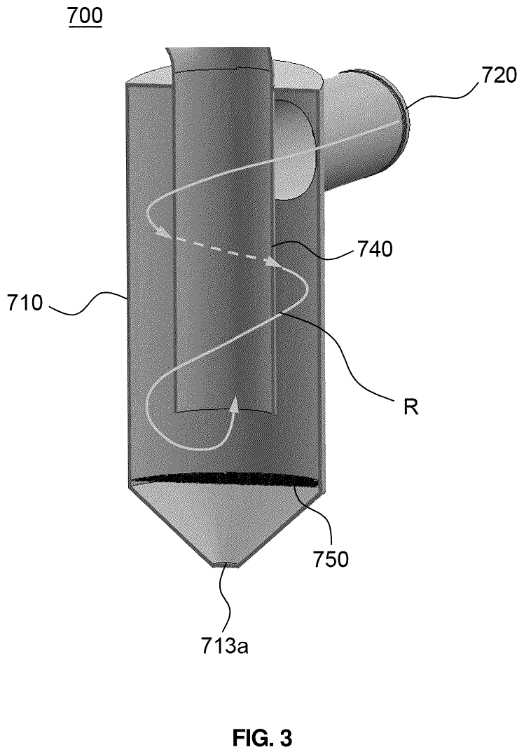

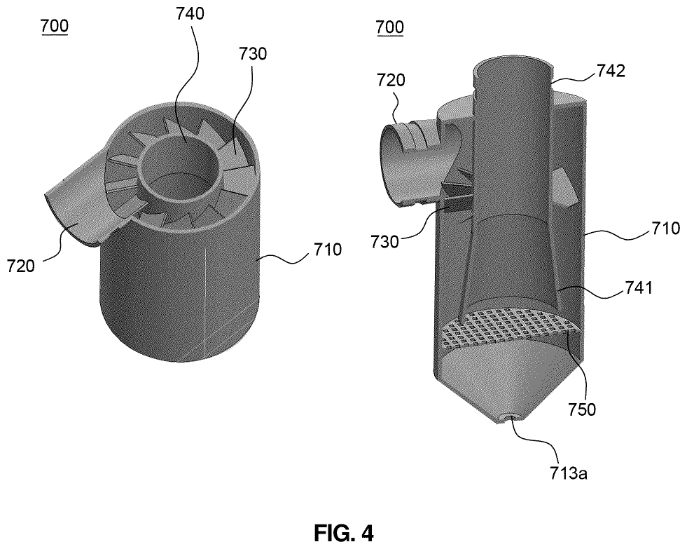

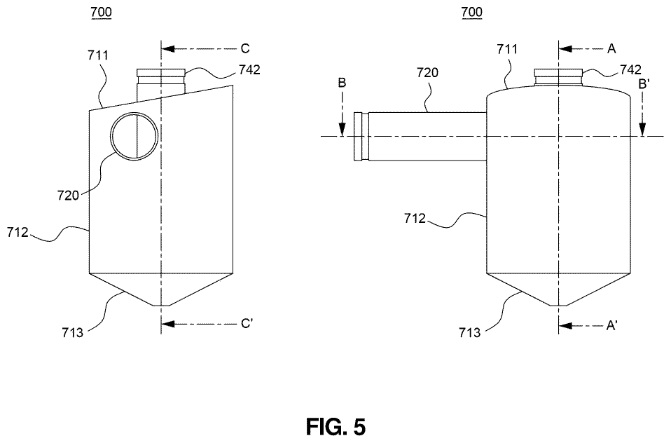

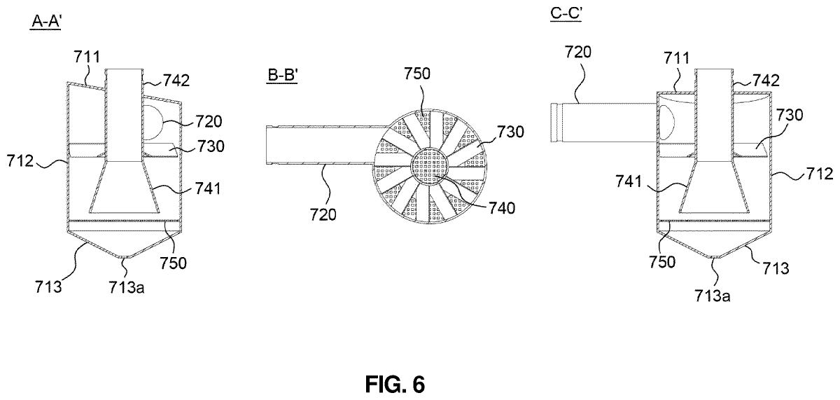

FIG. 1 illustrates a configuration diagram of a compressed air-moisture separating unit for a multistage turbocompressor system of the present invention, FIG. 2 illustrates a piping and instrumentation diagram (P & ID) for a multistage turbocompressor system equipped with the compressed air-moisture separating unit for a multi-stage turbocompressor system of the present invention, FIG. 3 illustrates a schematic view of the compressed air-moisture separating unit for a multi-stage turbocompressor system of the present invention, FIG. 4 illustrates a first reference view of the compressed air-moisture separating unit for a multi-stage turbocompressor system of the present invention, FIG. 5 illustrates a second reference view of the compressed air-moisture separating unit for a multi-stage turbocompressor system of the present invention, and FIG. 6 illustrates a third reference view of the compressed air-moisture separating unit for a multi-stage turbocompressor system of the present invention.

As illustrated in FIGS. 1 to 6, in the present invention, the compressed air-moisture separating unit (700) that removes moisture (condensed moisture) from compressed air compressed through a turbo air compression unit (300) is configured to include:
a cylindrical compressed air-moisture separation chamber housing module (710) that enables condensed moisture to be separated from the compressed air when the compressed air compressed by the turbo air compression unit (300) flows in;
a compressed air inlet module (720) that is formed by penetrating one side of an upper part of the compressed air-moisture separation chamber housing module (710) and is separated from a central axis of the compressed air-moisture separation chamber housing module (710) on purpose such that the compressed air discharged from the turbo air compression unit (300) flows in and whirls inside the compressed air-moisture separation chamber housing module (710);
an intra-compressed air moisture-removal flow guide vane module (730) that is rotated by the compressed air flowing in the compressed air inlet module (720), facilitates whirling of the compressed air flowing in the compressed air-moisture separation chamber housing module (710), induces the compressed air to flow to an intra-compressed air moisture-removal filtering housing module (740), and induces friction with the compressed air to remove condensed moisture from the compressed air;
the intra-compressed air moisture-removal filtering housing module (740) that is positioned coaxially inside the compressed air-moisture separation chamber housing module (710) and is formed in a specific shape to remove condensed moisture from the compressed air flowing in the compressed air-moisture separation chamber housing module (710) and discharge, to the outside, the compressed air from which the condensed moisture has been removed; and
a condensed moisture discharging mesh module (750) that enables the condensed moisture removed from the compressed air and condensed moisture droplets floating inside the compressed air-moisture separation chamber housing module (710) to be formed and discharged as moisture to the outside.

The compressed air flowing in through the compressed air inlet module (720) flows through a moisture-removed compressed air discharge route (R) that is formed from the compressed air inlet module (720) through an inner upper end portion of the compressed air-moisture separation chamber housing module (710) and then the intra-compressed air moisture-removal flow guide vane module (730) to an inside of the intra-compressed air moisture-removal filtering housing module (740) such that the compressed air from which the condensed moisture has been removed is discharged to the outside.

Primary removal of the condensed moisture is performed due to friction of the compressed air flowing in the compressed air-moisture separation chamber housing module (710) through the compressed air inlet module (720) against the inner upper end portion of the compressed air-moisture separation chamber housing module (710).

Secondary removal of the condensed moisture is performed due to friction of the compressed air against the intra-compressed air moisture-removal flow guide vane module (730).

Tertiary removal of the condensed moisture is performed due to friction of the compressed air against an inner wall of the compressed air-moisture separation chamber housing module (710) and an outer wall of the intra-compressed air moisture-removal filtering housing module (740).

Quaternary removal of the condensed moisture is performed due to friction of the compressed air against an inner wall of a lower end portion of the intra-compressed air moisture-removal filtering housing module (740).

As a result, moisture is removed from the compressed air compressed by the turbo air compression unit (300), and optimum compressed air is reliably obtained.

In other words, the condensed moisture contained in the flow of the compressed air flowing in the compressed air-moisture separating unit (700) is subjected to friction against an inner wall surface of the compressed air-moisture separating unit (700) due to centrifugal force, falls along the inner wall, is collected in a lower end portion, and is discharged to the outside.

In other words, the moisture is removed while the compressed air whirling and flowing inside the compressed air-moisture separating unit (700) moves along a specific route, and the condensed moisture droplets floating during the flow until the compressed air is discharged to the outside fall to the lower end portion of the compressed air-moisture separating unit (700) due to the inertia. Hence, only the compressed air from which moisture has been removed is induced to be discharged to the outside.

More specifically, the compressed air-moisture separation chamber housing module (710) is configured to include: an intra-compressed air condensed moisture-removal whirling space upper-end element (711) formed to have a specific inclination such that the compressed air flowing in from the compressed air inlet module (720) is induced to flow to an intra-compressed air condensed moisture-removal whirling space body element (712) and causes the compressed air flowing in from the compressed air inlet module (720) to be subjected to friction, so that the condensed moisture is primarily removed from the compressed air; the intra-compressed air condensed moisture-removal whirling space body element (712) in which the condensed moisture is removed from the compressed air while the compressed air flowing downward is whirled due to the friction against the intra-compressed air condensed moisture-removal whirling space upper-end element (711); and an intra-compressed air condensed moisture-removal whirling space bottom element (713) having a condensed moisture outlet (713a) through which the condensed moisture removed from the compressed air while the whirling is performed in the intra-compressed air condensed moisture-removal whirling space body element (712) falls and is discharged to the outside. As described above, while the compressed air flowing in from the compressed air inlet module (720) is whirled along the specific route, the condensed moisture is removed.

The compressed air inlet module (720) is formed to penetrate the compressed air-moisture separation chamber housing module (710) such that the compressed air discharged from the turbo air compression unit (300) flows in the compressed air-moisture separation chamber housing module (710), and is separated from the central axis of the compressed air-moisture separation chamber housing module (710) on purpose such that the compressed air flowing in the compressed air-moisture separation chamber housing module (710) is whirled and flows along the specific route.

The intra-compressed air moisture-removal flow guide vane module (730) is positioned below a position of the compressed air inlet module (720) formed at one side of an upper end of the compressed air-moisture separation chamber housing module (710) and inside the intra-compressed air condensed moisture-removal whirling space body element (712), is rotated by the compressed air flowing in from the compressed air inlet module (720), facilitates the compressed air to whirl and flow, and induces secondary friction with the compressed air to remove the condensed moisture from the compressed air.

The intra-compressed air moisture-removal filtering housing module (740) is formed in a funnel shape, and is configured to include an intra-compressed air moisture-removal filtering element (741) that has a trapezoidal cross section, and enables the condensed moisture to be finally removed from the compressed air before the compressed air whirling and flowing inside the intra-compressed air condensed moisture-removal whirling space body element (712) flows in a moisture-removed compressed air discharge passage element (742) and is discharged to the outside; and the moisture-removed compressed air discharge passage element (742) that extends from an upper end portion of the intra-compressed air moisture-removal filtering element (741) by a certain length, so that the compressed air from which the condensed moisture has finally been removed through the intra-compressed air moisture-removal filtering element (741) is discharged to the outside.

The condensed moisture is removed from the compressed air flowing in the compressed air inlet module (720) so that the optimum compressed air is discharged to the outside.

In this case, a reason for having the funnel shape is to increase a diameter of the intra-compressed air moisture-removal filtering element (741) to increase a flow rate of the compressed air whirling and flowing along an outer circumferential edge surface of the intra-compressed air moisture-removal filtering element (741) while reducing a flow rate of the compressed air flowing in the intra-compressed air moisture-removal filtering element (741), so that the floating droplets fall due to the inertia and are discharged to the outside through the condensed moisture discharging mesh module (750).

In other words, the funnel shape is formed to more effectively remove moisture from the compressed air.

The condensed moisture discharging mesh module (750) is positioned on one side between a lower part of the intra-compressed air condensed moisture-removal whirling space body element (712) and the intra-compressed air condensed moisture-removal whirling space bottom element (713) and is formed to penetrate in a specific pattern with a regular-interval particle size such that the condensed moisture removed from the compressed air is formed and falls to be discharged to the outside through the condensed moisture outlet (713a).

Meanwhile, when a multistage turbocompressor system (1) equipped with the compressed air-moisture separating unit (700) for the multistage turbocompressor system of the present invention is described as an example, the multistage turbocompressor system (1) including the compressed air-moisture separating unit is configured to include:
an outside air intake unit (100) through which outside air flows in and is suctioned in;
an outside air filtering unit (200) that filters the outside air flowing in and suctioned in through the outside air intake unit (100);
the turbo air compression unit (300) that generates compressed air when the outside air filtered from the outside air filtering unit (200) flows in and is suctioned in;
a turbo air compression cooling unit (400) that cools the turbo air compression unit (300);
a turbo air compression power supply unit (500) that drives the turbo air compression unit (300);
a compressed air cooling intercooler unit (600) that cools the compressed air generated through the turbo air compression unit (300);
the compressed air-moisture separating unit (700) that separates the condensed moisture from the compressed air cooled through the compressed air cooling intercooler unit (600); and
a compressed air outlet unit (800) through which the compressed air from which condensed moisture has been removed through the compressed air-moisture separating unit (700) is discharged.

The outside air suctioned into the outside air intake unit (100) passes through the outside air filtering unit (200), the turbo air compression unit (300), the compressed air cooling intercooler unit (600), and the compressed air-moisture separating unit (700), and the optimum compressed air from which moisture has been removed is to be discharged from the compressed air outlet unit (800).

In other words, as described above, when the outside air is compressed through the turbo air compression unit (300) and is discharged as the compressed air, the compressed air compressed through the turbo air compression unit (300) is to pass through the compressed air-moisture separating unit (700) before being discharged to the outside, so that the moisture (condensed moisture) contained in the compressed air can be removed, and the optimal compressed air from which the moisture (condensed moisture) has been removed can be obtained.

In this case, the compressed air outlet unit (800) is configured to include a compressed air external-supply discharge module (810) that enables the compressed air to be discharged to any place where the compressed air is required outside the multistage turbocompressor system (1) including the compressed air-moisture separating unit; and a compressed air internal-supply discharge module (820) that enables the compressed air to be discharged inside the multistage turbocompressor system (1) including the compressed air-moisture separating unit depending on ejection pressure of the compressed air discharged to the compressed air external-supply discharge module (810).

The compressed air internal-supply discharge module (820) is configured to include a blow-off valve element (821) that prevents backflow of the compressed air discharged to the compressed air external-supply discharge module (810) and induces the compressed air to smoothly flow; a compressed air volume control valve element (822) that adjusts the amount of compressed air flowing when the blow-off valve element (821) is opened; and a compressed air exhaust noise preventing muffler element (823) that reduces noise produced by the discharge of the compressed air. The compressed air is discharged and supplied internally and externally based on the multistage turbocompressor system (1) including the compressed air-moisture separating unit, so that the smooth flow of the compressed air flow is achieved.

In this case, the compressed air-moisture separating unit (700) is additionally formed in the compressed air internal-supply discharge module (820) such that moisture in the compressed air is removed again and the compressed from which moisture is removed is discharged inside the multistage turbocompressor system (1) including the compressed air-moisture separating unit.

As described in the configurations and operations, the present invention has the following effects.
1. Optimum compressed air from which moisture has been removed is obtained.
2. Since moisture is removed, a compression ratio is improved in outside air compression.
3. The service life of the multistage turbocompressor system is ensured and extended.

In other words, the service life of components constituting the multistage turbocompressor system, including piping and valves through which compressed air flows, is ensured and extended by preventing erosion, corrosion, microbial contamination, and freezing due to moisture contained in the compressed air.
4. Optimum compressed air from which moisture has been removed is obtained, and thus energy efficiency is maximized.

In other words, the present invention is a highly effective invention that obtains and discharges optimum compressed air from which moisture is removed, thereby maximizing the durability of the multistage turbocompressor system as well as energy efficiency.

It will be apparent to those skilled in the art that various modifications and variations can be made in the present invention without departing from the spirit or scope of the present invention as defined in the appended claims.

This invention can be implemented in many different forms without departing from technical aspects or main features. Therefore, the implementation examples of this invention are nothing more than simple examples in all respects and will not be interpreted restrictively.

### INDUSTRIAL APPLICABILITY

The present invention relates to the compressed air-moisture separating unit for a multistage turbocompressor system and can ensure and extend the durability and service life of the system in which the compressed air is used as well as the energy efficiency by enabling the optimal compressed air from which moisture has been removed to be provided to the manufacturing industry of manufacturing the system and the sales industry thereof, in particular, to industrial sites where the compressed air is required, thereby contributing to the promotion of various industries where the compressed air is used.

What is claimed is:

1. A compressed air-moisture separating unit (700) for a multistage turbocompressor system, the compressed air-moisture separating unit (700) comprising:
a cylindrical compressed air-moisture separation chamber housing module (710) that enables condensed moisture to be separated from compressed air when the compressed air compressed by a turbo air compression unit (300) flows in;
a compressed air inlet module (720) that is formed by penetrating one side of an upper part of the compressed air-moisture separation chamber housing module (710) and is separated from a central axis of the compressed air-moisture separation chamber housing module (710) on purpose such that the compressed air discharged from the turbo air compression unit (300) flows in and whirls inside the compressed air-moisture separation chamber housing module (710);
an intra-compressed air moisture-removal flow guide vane module (730) that is rotated by the compressed air flowing in the compressed air inlet module (720), facilitates whirling of the compressed air flowing in the compressed air-moisture separation chamber housing module (710), induces the compressed air to flow to an intra-compressed air moisture-removal filtering housing module (740), and induces friction with the compressed air to remove condensed moisture from the compressed air;
the intra-compressed air moisture-removal filtering housing module (740) that is positioned coaxially inside the compressed air-moisture separation chamber housing module (710) and is formed in a specific shape to remove condensed moisture from the compressed air flowing in the compressed air-moisture separation chamber housing module (710) and discharge, to the outside, the compressed air from which the condensed moisture has been removed; and
a condensed moisture discharging mesh module (750) that enables the condensed moisture removed from the compressed air and condensed moisture droplets floating inside the compressed air-moisture separation chamber housing module (710) to be formed and discharged as moisture to the outside, wherein
the compressed air flowing in through the compressed air inlet module (720) flows through a moisture-removed compressed air discharge route (R) that is formed from the compressed air inlet module (720) through an inner upper end portion of the compressed air-moisture separation chamber housing module (710) and then the intra-compressed air moisture-removal flow guide vane module (730) to an inside of the intra-compressed air moisture-removal filtering housing module (740) such that the compressed air from which the condensed moisture has been removed is discharged to the outside,
primary removal of the condensed moisture is performed due to friction of the compressed air flowing in the compressed air-moisture separation chamber housing module (710) through the compressed air inlet module (720) against the inner upper end portion of the compressed air-moisture separation chamber housing module (710),
secondary removal of the condensed moisture is performed due to friction against the intra-compressed air moisture-removal flow guide vane module (730),
tertiary removal of the condensed moisture is performed due to friction of the compressed air against an inner wall of the compressed air-moisture separation chamber housing module (710) and an outer wall of the intra-compressed air moisture-removal filtering housing module (740),
quaternary removal of the condensed moisture is performed due to friction of the compressed air against an inner wall of a lower end portion of the intra-compressed air moisture-removal filtering housing module (740), and
as a result, moisture is removed from the compressed air compressed by the turbo air compression unit (300), and optimum compressed air is reliably obtained.
